(19) United States
(12) Patent Application Publication
(10) Pub. No.: US 2012/0098207 A1
(43) Pub. Date: Apr. 26, 2012

(54) CROSSLINKABLE ULTRAVIOLET (UV) CURED COATING OVER FLOCK FIBERS FOR IMPROVED PERFORMANCE

(76) Inventors: Krishnamachari Gopalan, Troy, MI (US); Michael W. Pinter, South Lyon, MI (US); Jacob J. LaForest, MIlan, MI (US)

(21) Appl. No.: 13/201,019

(22) PCT Filed: Feb. 10, 2010
(86) PCT No.: PCT/US10/23747

§ 371 Date: Jan. 11, 2012

Related U.S. Application Data
(60) Provisional application No. 61/152,104, filed on Feb. 12, 2009.

(51) Int. Cl. B60J 10/00; B60J 10/04; F16J 15/02; B05D 1/00; C08F 2/48

(52) U.S. Cl. 277/500; 427/203; 427/508; 277/652; 277/651; 277/650

(57) ABSTRACT

A cross-linkable UV curable coating layer disposed over flocked fibers on an automotive component requiring improved squeak and itch resistance and freeze release is provided. The coating layer includes an elongated member having along a pre-determined portion of the member flocked fibers. The elongated member finds application as a weatherstrip or seal.

This application claims the priority benefit of U.S. Provisional Application Ser. No. 61/152,104, filed Feb. 12, 2009, the disclosure of which is hereby expressly incorporated herein by reference.

### BACKGROUND

The disclosure relates to a weatherstrip or weatherseal, and particularly one that includes a crosslinkable ultraviolet (UV) curable coating layer. The subject new weatherstrip finds use for improved performance where resistances to squeak and itch, and freeze release are required, for example, in an automotive vehicle.

Weatherstrips provided around a perimeter of an opening in a vehicle such as a door are common in the industry. For example, one or more weatherstrips are provided about the perimeter of a window in the door opening, for example along the A-pillar, header portion, B-pillar, etc. Furthermore, weatherstrips are also provided along the belt line between a window and the respective vehicle outer side and a vehicle inner side. Of course, these are exemplary and it is appreciated that weatherstrips are used in a wide variety of vehicle applications.

A known weatherstrip in a longitudinal body or strip may include a rigid core. It is common that the core is metal or a rigid, non-metal material while the body is an elastomer such as rubber or thermoplastic. The elastomer body may be molded or more commonly is extruded over the core.

In addition, flocked fibers or flock may be attached to at least a predetermined portion of the weatherstrip. The flocked fibers provide a low friction surface that selectively engages or abuts against the window and thus the need for low friction to allow the window to be more easily raised and lowered with reduced force. The flock also provides flexibility, squeak and itch resistance, freeze release and other desired properties. As an example, weatherstrips are initially coated with a low friction coating designed for squeak and itch and abrasion resistance. However, issues with squeak and itch resistance and abrasion to the seal were noted in the field. Therefore, the weatherstrip was modified from a coating to attaching flocked fibers or flock on selected portions of the weatherstrip.

It is also known to provide a temporary (i.e., non-cross-linkable) type coating, over the flocked fibers. Specific applications, such as a commercially available glass run seal, appear to use such a temporary and non-cross-linkable coating over flocked fibers.

Furthermore, although thermally cured cross-linkable coatings over flocked fibers have been suggested, these coatings present processing issues and capital equipment has already been invested for the flocking operation. Additional convection ovens would be required within the existing operation to cure the coating. Consequently, the processing time and equipment investment required for the thermally cured coating suggest that such modifications are not desired.

U.S. Patent Publication No. 2005/0215654 A1, entitled ULTRAVIOLET-CURABLE WATERBORNE COATING, by Wright, et al., discloses the use of an ultraviolet-curable, water based coating for weatherstrips, windshield wipers, door seals, trunk seals, sunroof seals, windshield seals and the like providing ice release, noise resistance, solvent resistance, abrasion resistance, weathering resistance, etc.

EP published application 1,728,809 A2 entitled WEATHERSTRIP COATING, by Dewiit, et al., discloses the use of a high viscosity coating for use in weatherstripping, windshield wiper blades, sunroof seals and similar applications that may be applied to an extruded rubber and the die head providing weathering resistance, solvent resistance, low noise and ice release. However, this high viscosity coating requires curing by a convection oven within the existing operation.

Thus, a non-temporary and more cost-effective need exists to improve upon the performance for squeak and itch resistance as well as freeze release associated with weatherstrips for automotive vehicles.

### SUMMARY OF THE DISCLOSURE

A weatherstrip having improved performance for squeak and itch resistance and freeze release includes an elongated member having flock along a pre-determined portion of the member and a coating layer disposed on the flock.

Preferably, the coating is crosslinkable UV curable where the coating self-crosslinks when activated by the photoinitiator's exposure to UV light. The coating then adheres to the elongated member.

A method of forming a weatherstrip having improved performance for squeak and itch resistance and freeze release includes providing an elastomeric body, flocking at least a portion of the body and applying a coating layer on the flock.

The method further includes curing the layer with UV.

A primary benefit of the disclosure is the ability to improve performance of the weatherstrip.

One advantage of the disclosure resides in the improved squeak and itch resistance, and improved freeze release.

Yet another benefit is the ability to easily incorporate the process into an existing manufacturing process without undue line extension or capital investment.

Still other features and benefits of the present disclosure will become apparent upon reading and understanding the following detailed description.

### BRIEF DESCRIPTION OF THE DRAWINGS

FIG. 1 is a perspective view of an automotive vehicle showing weatherstrips incorporating the subject disclosure.

FIG. 2 is a cross sectional view of a coated, flocked, extruded weatherstrip in accordance with this disclosure.

FIG. 3 is a diagrammatic process diagram showing a method for producing coated, flocked, extruded weatherstrip in accordance with this disclosure.

FIG. 4 is a diagrammatic process diagram showing another method for producing coated, flocked weatherstrip in accordance with this disclosure.

### DETAILED DESCRIPTION OF THE PREFERRED EMBODIMENTS

Aspects of an exemplary embodiment relate to a weatherstrip or seal, a method of forming a weatherstrip or seal, and a coating layer comprising a cross-linkable UV curable resin. The coating layer advantageously includes a cross-linkable UV curable resin. With this coating layer disposed on flocked fibers attached to a pre-determined portion of a weatherstrip or seal, the coating layer can improve the performance for squeak and itch resistance by a reduction of about 0.8 sones and freeze release by increase of about 70% and up to about 88% when compared to a weatherstrip that does not include the coating layer but only incorporate flock on the weatherstrip. As will be appreciated, this improvement is significant to reduce sones (unit of loudness) in the wet condition, and likewise the reduced Newtons of force can be represented by the percent reduction in force and again, these improvements are significant.

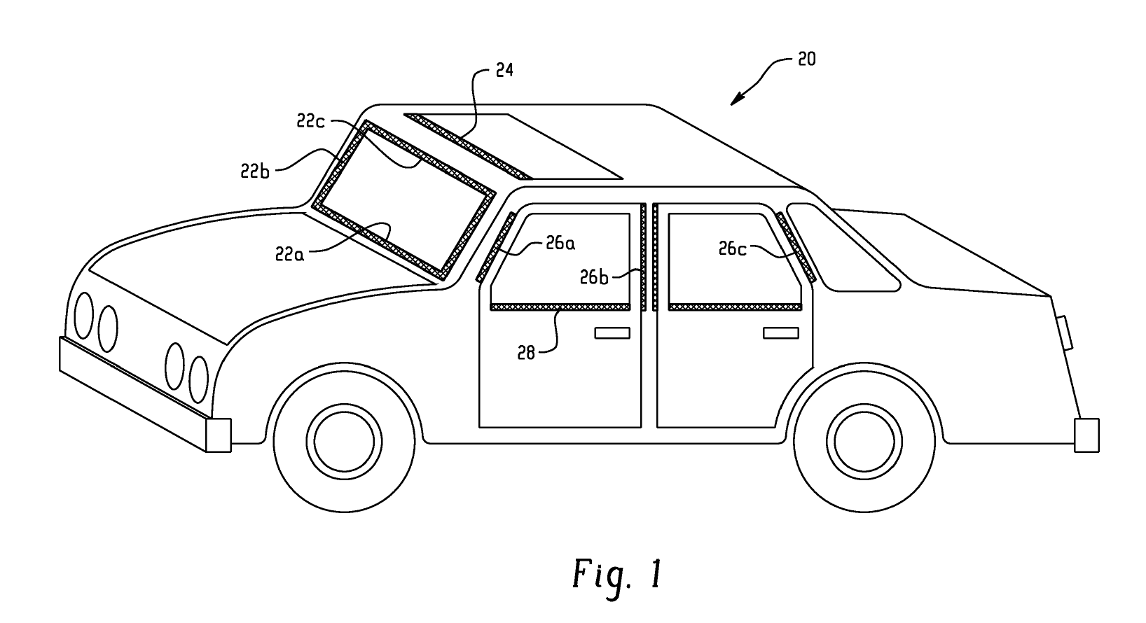

Turning initially to FIG. 1, there is shown an automotive vehicle 20 of the type having a variety of weatherstrips that may be improved by incorporating the teaching of the present disclosure. For example, these weatherstrips may be used as windshield weathersrip members 22a, 22b, and 22c, sun roof weatherstrip members 24, inner and outer belt weatherstrips 28 (inner belt not shown) and A-, B-, and C-Pillar weatherstrip members 26a, 26b, and 26c, and glass runs. Of course, one skilled in the art will appreciate that this list is not intended to be restrictive or all encompassing but rather exemplary of different types of weatherstrip or seals that may employ the teachings of the present disclosure. One or more of these components may require squeak and itch resistance, freeze release or a combination thereof.

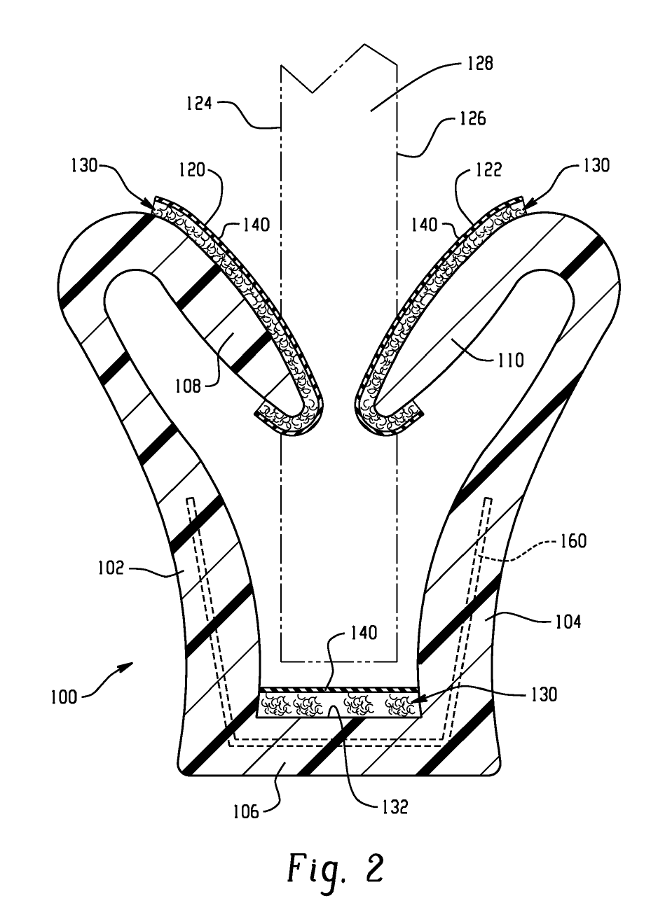

With reference to FIG. 2, there is illustrated, in a cross sectional view, an exemplary embodiment of a weatherstrip or seal 100 shown as a glass run seal that has a generally U-shape. More particularly, the glass run weatherstrip 100 includes first and second legs 102, 104 that extend outwardly from base 106. Outer or terminal ends of legs 102, 104 include seal lips 108, 110 respectively, that angle inwardly toward the opposite leg in a generally conventional manner. Each seal lip includes a region 120, 122 that is adapted for sliding, sealing engagement with an associated surface (shown here as opposite surfaces 124, 126 of movable window 128). It will also be appreciated that the seal lips are shown in a normal, unbiased position since the window is represented in dotted line. In actual use, the seal lips/legs will deflect as the window moves inwardly and outwardly relative to the glass run.

Preferably, and as is known, the seal lip regions 120, 122 may be provided with a low friction surface or coating that permits the sliding, sealing engagement with the window surfaces. It is common for the low friction surface to be a flock or flocked fibers 130 that are formed on those regions where dynamic interface occurs. Thus, the seal lip regions include flock 130, and other regions of the weatherstrip such as the inner surface 132 of the base 106 may also include flock 130. Although other surface areas of the weatherstrip may include a low friction surface flock, the surface treatment is typically limited to those areas that provide the dynamic seal interface. In other instances, flock may not be used and instead a coating having a low friction or lubricious surface is used.

Hence, a substantial improvement in freeze release, as well as an improved squeak and itch resistance, was achieved by using flock 130 over a predetermined portion of a weatherstrip body (e.g., glass run 102) in conjunction with a coating layer 140 on the flock. Preferably the coating layer is a material that will self cross-link and adhere to the flock and that is received on the material that forms the weatherstrip body (typically rubber or elastomer). In addition, the coating layer 140 is preferably ultraviolet (UV) curable. This is important because the ability to UV cure the coating layer allows the addition of this processing/manufacturing step to the existing processing or manufacturing line with only limited additional capital expenditure, namely an applicator or application stage and an irradiation or UV source disposed immediately downstream that cures the coating layer.

An exemplary coating layer includes the product Cooper-Standard Automotive SPS278 Black Waterborne UV Cure Coating. In a preferred embodiment, the final dry film thickness is on the order of approximately 20-25 microns.

The exemplary weatherstrip has improved performance for squeak and itch resistance. With a cross-linkable UV curable coating layer applied on flocked fibers attached to a predetermined portion of the weatherstrip or seal, the exemplary embodiment has improved performance for squeak and itch resistance of a reduction of about 0.8 sones compared to a weatherstrip embodiment that does not include a coating layer over the flock (i.e., flock only).

Furthermore, the exemplary weatherstrip has improved freeze release. With a cross-linkable UV curable coating layer applied on flocked fibers attached to a predetermined portion of the weatherstrip or seal, the exemplary embodiment exhibits improved performance for freeze release on the order of about 70% to about 80% compared to an embodiment having flock without a coating layer.

### Squeak and Itch Resistance

The exemplary weatherstrip has considerable performance improvement for squeak and itch resistance in comparison to previously uncoated flocked fibers attached to a pre-determined portion of the exemplary embodiment. Table 1 shows measured squeak and itch resistance using a conventional test method GM 9842P: Revision D (Measurement of Acoustic Output of Dynamic Trim and Sealing Components Involved in Shear Movement). The value for the wet measurement indicates the embodiment of coating over flocked fibers is at least a reduction of about 0.8 sones.

TABLE 1
Squeak and Itch Test Results

| | | Cooper-Standard |
|---|---|---|
| GMNA GM9842P: | | Automotive |
| Revision D | | SPS278 Coating |
| (average of 9 | Uncoated | (coating over flocked |
| measurements) | (flocked fibers only) | fibers) |
| Dry | | |
| High | 3.0 sones | 3.2 sones |
| Low | 2.2 sones | 2.3 sones |
| Average | 2.6 sones | 2.6 sones |
| Wet | | |
| Dry | 3.4 sones | 2.3 sones |
| Low | 2.4 sones | 1.6 sones |
| Average | 2.8 sones | 2.0 sones |

### Freeze Release

The exemplary weatherstrip or seal, furthermore, has considerable improvement for freeze release in comparison to previously uncoated flocked fibers attached to a pre-determined portion of the exemplary embodiment. Table 2 shows measured freeze release using a conventional test method GM 9894D (Freeze Characteristics of Weatherstrips). The value indicates the embodiment of Cooper-Standard Automotive SPS 278 crosslinkable UV curable coating over flocked fibers is about an 80% improvement.

TABLE 2
Freeze Release Results

| | | Cooper-Standard |
|---|---|---|
| | | Automotive |
| | | SPS278 Coating |
| | Uncoated | (coating over flocked |
| | (flocked fibers only) | fibers) |
| Freeze Release | 50.658 | 6.159 |
| (in Newtons) | | |

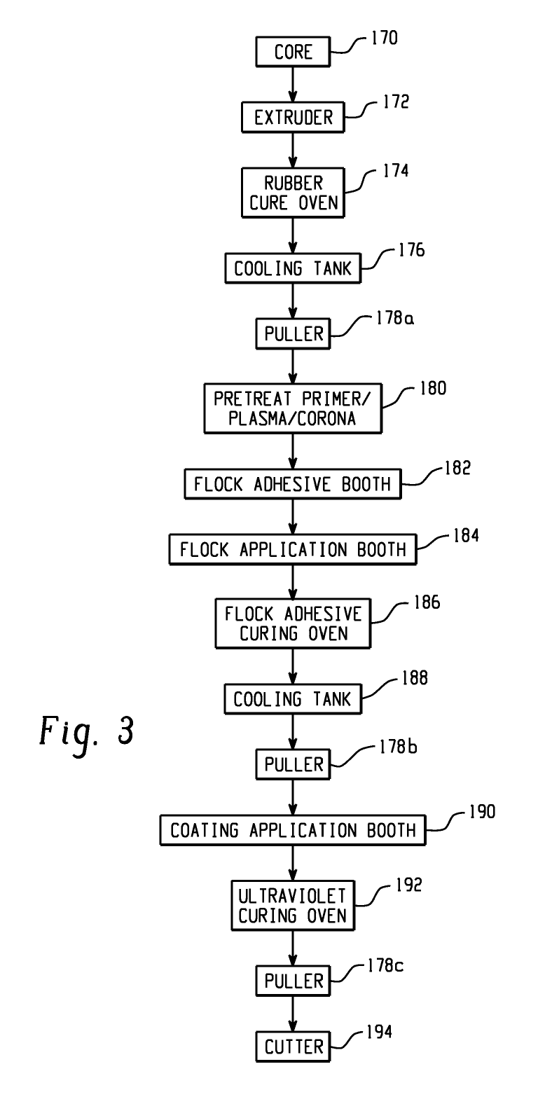

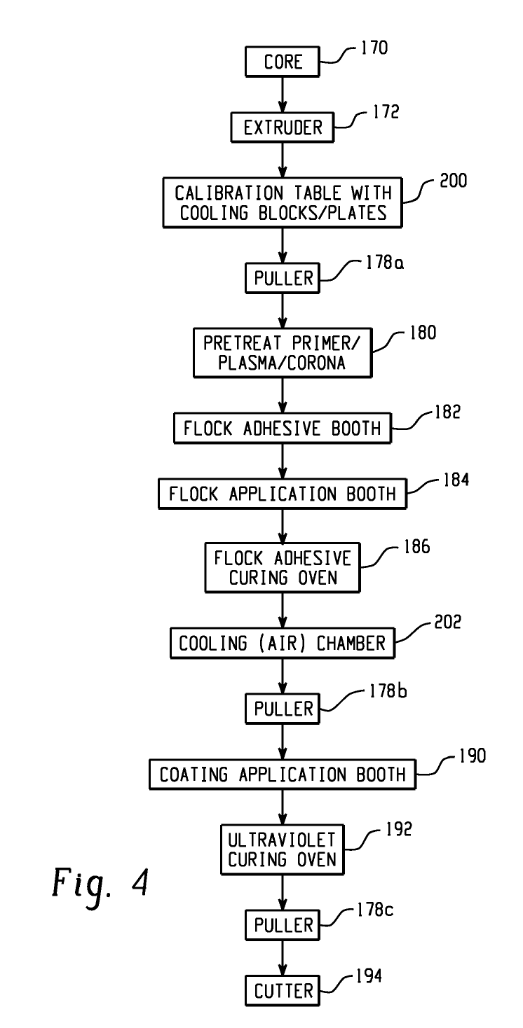

FIG. 3 is generally representative of the processing steps associated with the manufacture of the weatherstrip of the present disclosure. More particularly, a rigid core 160 (represented in FIG. 2 even though the illustrated glass run or another type of weatherseal may not employ a core) is introduced into the line (step 170). The core can be inserted in a desired configuration or roll-formed into the desired shape. Next, the elastomer body is received over the core (if a core is used) (step 172). Usually, the elastomer is extruded. The extruded elastomer is advanced to cure in an oven (step 174). It is then cooled (step 176). The extruded elastomer continues to be advanced through the line by a puller (steps 178a, 178b, and 178c). Flock is then applied as represented at step 182, 184, 186 and 188. Frequently, the coating layer is applied over the flock as represented by step 190, then cured at step 192 and cut at step 194. Of course, FIG. 3 is representative of an extruded rubber line and it will be appreciated that the disclosure also has application with a thermoplastic (TP) material (which includes TPE, TPO, TPV, etc.), for example, such as shown in FIG. 4. The steps in FIG. 4 are similar to those in FIG. 3 but do not require the rubber cure oven 174 and the cooling tank 176. Instead, a calibration table 200 containing cooling blocks and/plates is used to cool the material after it leaves the extruder. In addition, the cooling tank 188 in the FIG. 3 process is substituted with a cooling chamber 202, such as a cooling air chamber.

In comparison to a thermally cured cross-linkable coating disposed on flocked fibers attached to a predetermined portion of a weatherstrip, the cross-linkable UV curable coating layer disclosed herein has specific advantages. For example, the requirement for additional convection ovens is eliminated to cure the coating layer. Thereby, replacing these ovens is a much shorter UV cure unit.

In one embodiment, the weatherstrip includes an elongated member having along a pre-determined portion of the member flocked fibers and a coating layer disposed on the flocked fibers, which serve for use on an automotive component. The elongated member includes an extrusion, may optionally include a core, flocked fibers attached to a predetermined portion of the member and a coating layer disposed on the flocked fibers. The extrusion is an elastomeric material and the core is metal or a rigid, non-metal material. Prior to applying the coating layer, the flocked fibers are fully prepared and cured. The coating layer is a cross-linkable UV curable resin containing composition.

The cross-linkable UV curable resin can be selected from a combination of one or more polyurethane dispersions and one or more photoinitiators. The polyurethane dispersions provide flexibility, improved weathering resistance and solvent resistance, and double bonds for UV cure with a photoinitiator. The photoinitiator component of the coating layer provides UV cure through radical polymerization with the polyurethane dispersion(s).

The invention has been described with reference to the preferred embodiments. Obviously, modifications and alterations will occur to others upon reading and understanding the preceding detailed description. It is intended that the invention be construed as including all such modifications and alterations.

What is claimed is:

1. A weatherstrip for use on an automotive component comprising:
an elongated member having flock along a pre-determined portion; and a coating layer disposed on the flock for improving at least one of (i) freeze release and (ii) squeak and itch resistance.

2. The weatherstrip of claim 1, wherein the coating includes a cross-linkable UV curable resin.

3. The weatherstrip of claim 1, wherein the flock is fully prepared and cured.

4. The weatherstrip of claim 1, wherein the weatherstrip further includes a rigid core at least partially received in the elongated member.

5. The weatherstrip of claim 4, wherein the core is metal.

6. The weatherstrip of claim 4, wherein the core is a rigid, non-metal material.

7. The weatherstrip of claim 1, wherein the weatherstrip has configuration adapted for extrusion.

8. The weatherstrip of claim 7, wherein the extrusion is an elastomeric material.

9. The weatherstrip of claim 7 wherein the extrusion is a thermoplastic material.

10. A weatherstrip for use on an associated automotive vehicle as a seal or glassrun comprising:
an elongated body having flock disposed along surface portions thereof for engagement with an adjacent surface or window on the associated vehicle; and
means for improving freeze release and squeak and itch resistance provided over the flock.

11. The weatherstrip of claim 10 wherein the improving means includes a cross-linkable UV coating that is curable in less than 25 seconds with the body.

12. A method of forming a weatherstrip comprising:
providing one of an elastomeric or plastomeric body;
flocking at least a portion of the body; and
applying a coating layer on the flock to improve at least one of (i) freeze release and (ii) itch and squeak resistance.

13. The method of claim 12, wherein the providing step includes attaching flocked fibers along a predetermined portion of the body.

14. The method of claim 13, wherein the flocked fibers are fully prepared for attaching along a predetermined portion of the body.

15. The method of claim 13, wherein the flocked fibers are fully cured after attaching along a predetermined portion of the body.

16. The method of claim 12, wherein the body providing step includes applying a crosslinkable UV curable coating layer on the flocked fibers.

17. The method of claim 16, wherein the coating layer is irradiated to cure the layer within 1 to 9 seconds.

18. The method of claim 16, wherein the coating layer is applied at a thickness on the order of 5 to 40 microns, more preferably 20 to 25 microns to provide for improved squeak and itch resistance and freeze release.

19. The method of claim 12, wherein the providing step includes the step of extruding the body.

20. The method of claim 12, wherein the providing step includes incorporating a core in the body.
